(19) United States
(12) Patent Application Publication
(10) Pub. No.: US 2024/0020603 A1
(43) Pub. Date: Jan. 18, 2024

(54) DETECTING AND REMEDIATING LOGISTICAL OPERATIONAL DELAYS

(71) Applicant: United States Postal Service, Washington, DC (US)

(72) Inventors: Mary Beth LEVIN, Washington, DC (US); Nicholas John SUCICH, Manassas, VA (US); Qiao ZHANG, Herndon, VA (US)

(21) Appl. No.: 18/352,747

(22) Filed: Jul. 14, 2023

Related U.S. Application Data
(60) Provisional application No. 63/389,532, filed on Jul. 15, 2022.

(51) Int. Cl. G06Q 10/0631; G06Q 10/0833; G06Q 10/067

(52) U.S. Cl. CPC G06Q 10/06312; G06Q 10/0833; G06Q 10/067

(57) ABSTRACT

Techniques for detecting and remediating logistical operational delays are presented. The techniques can include: obtaining electronic operational feedback associated with logistics in a geographical region, where the electronic operational feedback includes at least one of: customer email messages, customer phone messages, web-based customer reviews, delivery delay times, social media communication issue resolution times, or employment satisfaction ratings; generating a heatmap representing the electronic operational feedback for the geographical region, where an operational issue hotspot corresponding to a logistical node in the geographic region is displayed; and remediating an operation issue at the logistical node in the geographic region that corresponds to the operational issue hotspot.

### RELATED APPLICATION

This application claims the benefit of U.S. Provisional Patent Application No. 63/389,532 entitled, “DETECTING AND REMEDIATING LOGISTICAL OPERATIONAL DELAYS,” filed Jul. 15, 2022, which is hereby incorporated by reference herein in its entirety.

### FIELD

This disclosure relates generally to logistics, such as logistics provided by package delivery services.

### BACKGROUND

Package delivery services face many logistical challenges, including those related to package intake, package processing, package staging, package movement, and package delivery. For package delivery services that operate in large geographic areas, identifying operational issues can be challenging. For example, when operating at a sufficiently large scale, all package delivery services will receive some amount of negative feedback from customers. However, for a particular location, it is difficult to determine whether received negative feedback represents a typical amount, or an amount that is indicative of an operational issue that requires correction. Further, in general, it is difficult to determine an appropriate remedy for logistical operational issues based on customer feedback.

### SUMMARY

According to various embodiments, a method of detecting and remediating logistical operational delays is disclosed. The method includes obtaining, by an electronic processor, electronic operational feedback associated with logistics in a geographical region, where the electronic operational feedback includes at least one of: customer email messages, customer phone messages, web-based customer reviews, delivery delay times, social media communication issue resolution times, or employment satisfaction ratings; generating, by the electronic processor, a heatmap representing the electronic operational feedback for the geographical region, where an operational issue hotspot corresponding to a logistical node in the geographic region is displayed; and remediating an operation issue at the logistical node in the geographic region that corresponds to the operational issue hotspot.

Various optional features of the above embodiments include the following. The remediating can include increasing a number of operational sorting machines at the logistical node. The remediating can include increasing an amount of storage space at the logistical node. The remediating can include increasing a number of vehicle interactions with the logistical node. The heatmap can be partitioned according to ZIP Codes. The logistical node can include a hub or a distribution center. The method can further include obtaining second electronic operational feedback including social media communications; and displaying a second heatmap representing the second operation feedback. The heatmap can be partitioned into geographic parts, and the electronic operational feedback can include at least one of: customer email messages or customer phone messages, and the method can further include: extracting package tracking information from the electronic operational feedback; and determining the geographic parts corresponding to the package tracking information. The electronic operational feedback can include at least one of: customer email messages or customer phone messages, and the method can further include: extracting a tag from the electronic operational feedback; and displaying a second heatmap representing a frequency of the tag for the geographical region. The electronic operational feedback can include at least one of: customer email messages or customer phone messages, and the method can further include: displaying a second heatmap representing operational feedback response times.

According to various embodiments, a system for detecting and remediating logistical operational delays is disclosed. The system includes an electronic processor and a non-transitory computer readable medium including instruction that when executed by the electronic processor cause the electronic processor to perform actions including: obtaining electronic operational feedback associated with logistics in a geographical region, where the electronic operational feedback includes at least one of: customer email messages, customer phone messages, web-based customer reviews, delivery delay times, social media communication issue resolution times, or employment satisfaction ratings; and generating a heatmap representing the electronic operational feedback for the geographical region, where an operational issue hotspot corresponding to a logistical node in the geographic region is displayed; where an operation issue is remediated at the logistical node in the geographic region that corresponds to the operational issue hotspot.

Various optional features of the above embodiments include the following. The operational issue can be remediated by increasing a number of operational sorting machines at the logistical node. The operational issue can be remediated by increasing an amount of storage space at the logistical node. The operational issue can be remediated by increasing a number of vehicle interactions with the logistical node. The heatmap can be partitioned according to ZIP Codes. The logistical node can include a hub or a distribution center. The actions can further include: obtaining second electronic operational feedback including social media communications; and displaying a second heatmap representing the second operation feedback. The heatmap can be partitioned into geographic parts, and the electronic operational feedback can include at least one of: customer email messages or customer phone messages, and the actions can further include: extracting package tracking information from the electronic operational feedback; and determining the geographic parts corresponding to the package tracking information. The electronic operational feedback can include at least one of: customer email messages or customer phone messages, and the actions can further include: extracting a tag from the electronic operational feedback; and displaying a second heatmap representing a frequency of the tag for the geographical region. The electronic operational feedback can include at least one of: customer email messages or customer phone messages, and the actions can further include: displaying a second heatmap representing operational feedback response times.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 is a schematic diagram of a system for, and method of, identifying and remediating logistical operational issues according to various embodiments;

FIG. 2 is a schematic diagram of a computerized system for receiving, consolidating, and distilling electronic operational feedback according to various embodiments; and

FIG. 3 is a graphical user interface showing a visualization dashboard, including a heatmap representing electronic operational feedback, according to various embodiments.

### DESCRIPTION OF THE EMBODIMENTS

Reference will now be made in detail to example implementations, illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

Some embodiments solve the problem of detecting and remediating logistical operational issues, e.g., a for package delivery service that operates over a large geographic area such as a state, region, or country, (e.g., the U.S. Postal Service (U.S.P.S.), FEDERAL EXPRESS, UNITED PARCEL SERVICE, or the like. Some embodiments process electronic operational feedback regarding logistics in a geographical region. Such electronic operational feedback can be obtained from, for example, social media communications (e.g., posts or messages) from customers, email messages from customers, phone messages from customers, and/or employee or customer satisfaction ratings. Some embodiments process the electronic operational feedback and generate a heatmap representing logistical operational issues (e.g., problems) in the geographic area. In various embodiments, the heatmap may be a graphical representation of data where values are depicted by color, shades of gray, or the like. The heatmap may identify a logistical node, e.g., a logistical hub, distribution center, network distribution center, area distribution center, sectional central facility, or destination delivery unit, that has a disproportionate amount of negative electronic operational feedback. Once the logistical node is identified, some embodiments remediate the logistical operational issue, e.g., by ensuring that sufficient vehicles are present and available at the appropriate places and at the appropriate times, ensuring that sufficient sorting machines are present and operational at the appropriate places and at the appropriate times, ensuring that sufficient personnel are present and available at the appropriate places and at the appropriate times, and/or ensuring that sufficient package storage space is available at the appropriate places and at the appropriate times.

These and other features and advantages are presented in reference to the figures as described below.

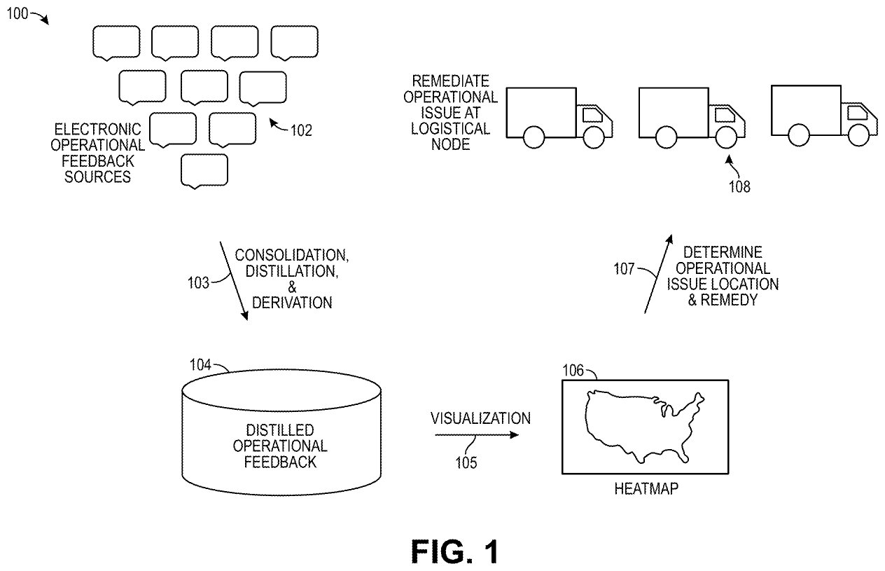

FIG. 1 is a schematic diagram of a system for, and method of, 100 identifying and remediating logistical operational issues of a package delivery service according to various embodiments. The system and method may be partially implemented using a computer having an electronic processor.

The system and method 100 obtain electronic operational feedback from, or derived from, one or more electronic operational feedback sources 102. Such sources can include, by way of non-limiting example, customer feedback, which may include customer satisfaction ratings, obtained from a web page or site such as a consumer rating web page, e.g., YELP. Such sources may include consolidated feedback from multiple web pages. Another non-limiting example, electronic operational feedback sources can include social media communications, such as social media posts or social media direct messages. Social media can include publish-and-subscribe sources such as TWITTER and traditional social media sources or sites such as FACEBOOK. Direct messages may be sent to a social media account of the package delivery service. As another non-limiting example, electronic operational feedback sources can include email messages from customers, e.g., to an email address of the package delivery service. As another non-limiting example, electronic operational feedback sources can include aural phone messages from customers, e.g., to a phone number of the package delivery service. The aural phone messages may be processed using known speech-to-text techniques to obtain text files representing the messages. As another non-limiting example, electronic operational feedback sources can include text messages from customers, e.g., SMS messages to a phone number of the package delivery service. As another non-limiting example, electronic operational feedback sources can include employee satisfaction ratings of the package delivery service, e.g., to employment rating web pages such as GLASS DOOR. As another non-limiting example, electronic operational feedback sources can include package tracking systems, such as a package tracking system of the package delivery system.

The system and method 100 derives (for some electronic operational feedback data types), consolidates, and distills 103 data from the electronic operational feedback sources 102. As described presently, various embodiments may operate on electronic operational feedback data obtained directly, or derived, from any of a variety of sources, including, by way of non-limiting examples: web-based customer ratings, customer phone messages (aural, textual), customer emails, social media communications (posts, direct messages), delivery tracking information, and/or employment satisfaction ratings. Some electronic operational feedback data types may be obtained directly from the electronic operational feedback sources, such as: web-based customer ratings, customer phone messages (aural, textual), customer emails, social media communications (posts, direct messages), and employment satisfaction ratings. Other types of electronic operational feedback data types may be derived from data obtained from the electronic operational feedback sources, such as: delivery delay times, and communication response and issue resolution times for social media communications, email, and phone messages. For example, social media communication response and/or resolution times for issues raised on social medial communications may be derived from social media communications an internal issue tracking records, and delivery delay times may be derived from package tracking systems.

The electronic operation feedback can be processed to distill or identify information that is useful to the system, such as tags that identify useful information, such as “late,” “damage,” etc. For example, any message from a customer containing “APO,” “FPO,” “DPO,” or “military” may be tagged as “Military Mail”. Further, location information may be determined from the electronic operational feedback. For example, a ZIP Code may be extracted from any feedback that includes a ZIP Code. As another example, any feedback that includes a tracking number may be processed to extract the tracking number, and the tracking number may be analyzed using the package delivery service's tracking system to identify an origination location and a destination location, each of which may be stored in association with the feedback. For consumer rating web pages that quantify reviews, e.g., in terms of a number of stars out of a maximum number, the review data may be extracted from the feedback. Any of the feedback may be subjected to automated sentiment analysis, and the feedback may be associated with an indication of the results of such analysis.

The system and method 100 then consolidates or stores the electronic feedback, which can include derived and distilled information. The storage may be in electronic persistent storage 104, e.g., in a cloud storage environment. The consolidated electronic operational feedback may be stored in one or more data structures, such as in comma separated format, or in a database. Personally identifying information may be removed from the electronic operational feedback prior to storage. As noted, the electronic operation feedback can be stored in association with any derived or distilled information. Thus, for example, the text of a social media post may be stored in association with an included ZIP Code, one or more tags, and/or a sentiment analysis result.

The system and method 100 then processes 105 the stored operational feedback to produce visualization data. For example, the feedback may be clustered according to location information. In general, the geographic area in which the package delivery service operates may be partitioned into parts (e.g., ZIP Code, state, or region). Each feedback entry in the persistent storage that includes location information may be associated with one of the parts of the partition. According to some embodiments, feedback data may be associated with specific logistical nodes, such as logistical hubs; distribution centers, or the like. The system and method 100 then determines visualization data for each part of the partitioned geographic area and/or each logistical node. The visualization data for each part in the geographic area or logistical node may include any, or any combination, of: number of social media communications (combined or individually: posts, direct messages), number of email messages, number of phone messages (combined or individually: aural, textual), number of web-based ratings for each rating possibility (e.g., for each number of stars from zero to a maximal number of stars, or for each sentiment category, such as positive, neutral, or negative), total number of web-based ratings, number of employee satisfaction ratings for each rating possibility (e.g., for each number of stars from zero to a maximal number of stars, or for each sentiment category, such as positive, neutral, or negative), total number of employee satisfaction ratings, number of tags of each tag type, delivery delay times, communication response and/or issue resolution times (e.g., for email communications, aural phone message communications, textual phone message communications, social media post communications, social media direct message communications, or all types of communications combined), total number of feedback entries in all categories, etc.

The system and method 100 then generates a visualization of the feedback data in the form of a heatmap 106. According to some embodiments, a different heatmap may be generated for each feedback data type. Thus, some embodiments generate a different heatmap for each of: number of social media communications (combined or individually: posts, direct messages), number of email messages, number of phone messages (combined or individually: aural, textual), number of web-based ratings for each rating possibility (e.g., for each number of stars from zero to a maximal number of stars, or for each sentiment category, such as positive, neutral, or negative), total number of web-based ratings, number of employee satisfaction ratings for each rating possibility (e.g., for each number of stars from zero to a maximal number of stars, or for each sentiment category, such as positive, neutral, or negative), total number of employee satisfaction ratings, number of tags of each tag type, delivery delay times, communication response and/or issue resolution times (e.g., for email communications, aural phone message communications, textual phone message communications, social media post communications, social media direct message communications, or all types of communications combined), total number of feedback entries in all categories, etc. The heatmap may represent each partition and/or logistical node as a shape, e.g., a dot, colored according to the corresponding heatmap datum. The color may represent a location on a continuum of colors, e.g., from blue, to green, to yellow, to orange, to red, representing the relative magnitude of the visualization data. The heatmap data for a particular feedback data type may be normalized across the parts of the geographical area prior to being associated with a color.

The system and method 100 then determines 107 an operational issue hotspot (e.g., a location that has outlier, unusual, and/or undesirable data associated with it) from one or more heatmap. For example, the heatmap datum for one or more locations, as represented by a partition part or logistical node, may visually appear different from the other heatmap data for the other locations. This difference may be determined visually, or by an automated process, e.g., a machine learning process. For example, such data-outlier hotspot locations may be identified by determining one or more local or global minima or maxima (e.g., the locations associated with the minima and/or maxima data, (for example most customer complaints), are determined to be hotspots); by comparing a location's data to a threshold(s), (e.g., the locations associated the data that exceeds, or fails to exceed, a threshold, (for example, average customer rating less than three out of five stars), are determined to be hotspots); and the like. The heatmap can also be used to identify hotspots on a particular operational issue, such as informed delivery. For heatmap parts, a corresponding included logistical node(s) may be identified for each operational hotspot.

In various embodiments, the system and method 100 also determines a remedy for the identified location, node, locations, or nodes. For example, the remedy may be any, or any combination, of: increasing a number of operational sorting machines (or other equipment associated with the problem) at the identified logistical node, e.g., by installing additional machines and/or fixing nonfunctional machines, automatically activating idle equipment at the identified logistical node, increasing an amount of logistical storage space at the identified logistical node, increasing the amount of personnel at the identified logistical node, increasing a number of logistics vehicle interactions with the identified logistical node, and/or other activations of, increases to, improvements to, repairs to, or replacements of resources at the identified logistical node.

The system and method 100 then remediates 108 the logistical operational issue at the identified logistical node by initiating or implementing the identified remedy. In various examples, the remediation may include repairing nonfunctional sorting machines, or installing additional sorting machines, at the identified logistical node. The remediation may include installing additional shelving, requisitioning additional space, or acquiring additional storage property at or near the identified logistical node. The remediation may include allocating or acquiring additional vehicles for delivery to, or pickup from, the identified logistical node, or allocating or acquiring additional vehicle docking space at the identified logistical node. The remediation may include remotely activating idle equipment (e.g., a sorting machine or the like) at the identified logistical node.

Accordingly, various embodiments of the system and method 100 both identify problems and their locations, and solve the identified problems, for logistical operational issues regarding intake, processing, staging, movement, and delivery of packages across a large geographic area.

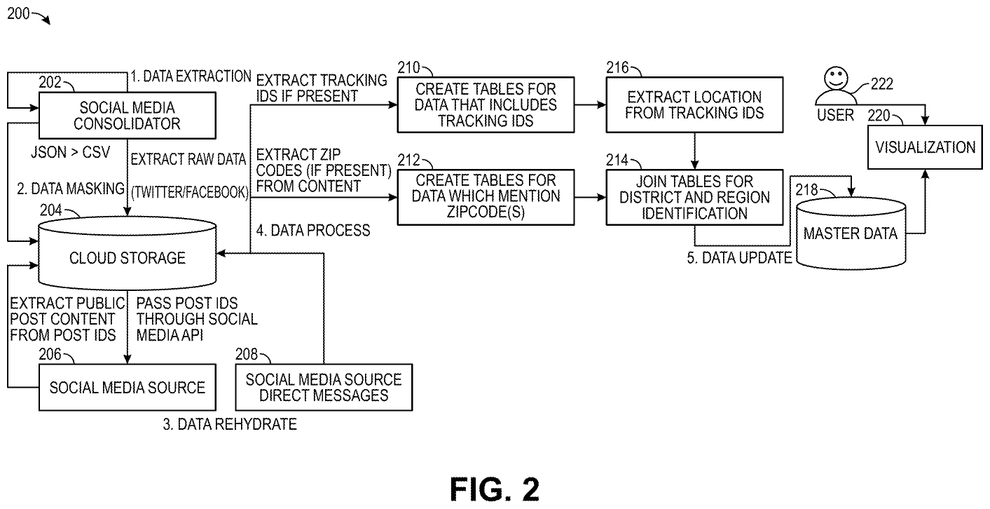

FIG. 2 is a schematic diagram of a computerized system 200 for receiving, consolidating, and distilling electronic operational feedback according to various embodiments. The computerized system 200 may be used to implement the system and method 100 as shown and described herein in reference to FIG. 1. The system 200 may be implemented, partially or fully, in a cloud-based virtual machine according to some embodiments. In general, the system 100 may operate as described presently when activated manually or periodically, e.g., daily, every twelve hours, or every six hours.

Initially, a social media consolidator 202, e.g., the LITHIUM social media monitoring platform, provides extracted social media data. The social media consolidator may identify or determine all social media communications from one or more selected social media sources that relate to the package delivery service. For example, the social media consolidator may identify as being relevant the social media communications that mention a username or handle of a specific package delivery service, such as the U.S.P.S. As another example, the social media consolidator may identify as being relevant the social media communications that are directed or sent to the package delivery service, e.g., in a post or in a direct message. The social media consolidator 202 may provide the social media communication content and/or IDs corresponding to the social media communication content to the system.

For social media sources that permit the social media consolidator 202 to extract communication content, the extracted communication data may be stored in a cloud storage 204. The communication data, including content, may be acquired through an API of the social media consolidator 202 for storage. The communication data may be extracted using Python code, which may be run in the cloud-based virtual machine.

For social media sources 206 that do not permit the social media consolidator 202 to extract communication content, such as TWITTER, the social media communication content may be extracted through an API of the social media source 206 using the social media communication IDs provided by the social media consolidator 202 in a process referred to as “rehydration.” Social media direct messages 208 may be processed separately from social media posts provided by the social media source 206. Authorized access may be a requirement for obtaining direct message social media communication content.

In case customers mention an address or name in the social media communication, the social media content may undergo data masking to remove any personally identifying information. The data masking can operate in an automated way, triggered when new social media communication data is stored and available. This ensures that no sensitive data is stored in cloud storage 204.

New data being stored in the cloud storage 204 may trigger a function in the system 200, e.g., in the cloud-based virtual machine, that processes the data to extract location identification information that is useful for identifying specific geographic parts such as, by way of non-limiting examples, tracking IDs and ZIP Codes. Data representing other types of geographic partition parts may be extracted in addition or in the alternative. Thus, at 210, tables for the social media communications data that includes tracking IDs are created, and at 216, location information, such as partition part (or logistical node) location information is extracted or obtained from the tracking system of the package delivery service based on the tracking IDs, e.g., using a query to an API. In various embodiments, no personally identifiable information is taken or stored from the tracking number query response. Further, at 212, tables for data that includes ZIP Codes (or other geographic part identifiers) in the social media communications data are created. The extracted tracking IDs and ZIP Codes (or other geographic part identifiers) are joined or associated at 214 with the corresponding social media communication content and stored in the master visualization data 218, which may be implemented in cloud-based storage.

The master visualization data 218 may update automatically upon new data populating the cloud storage 204. The master visualization data 218 may include social media communication content, as well as any distilled or derived information, associated with respective geographic area parts and/or logistical node identifiers.

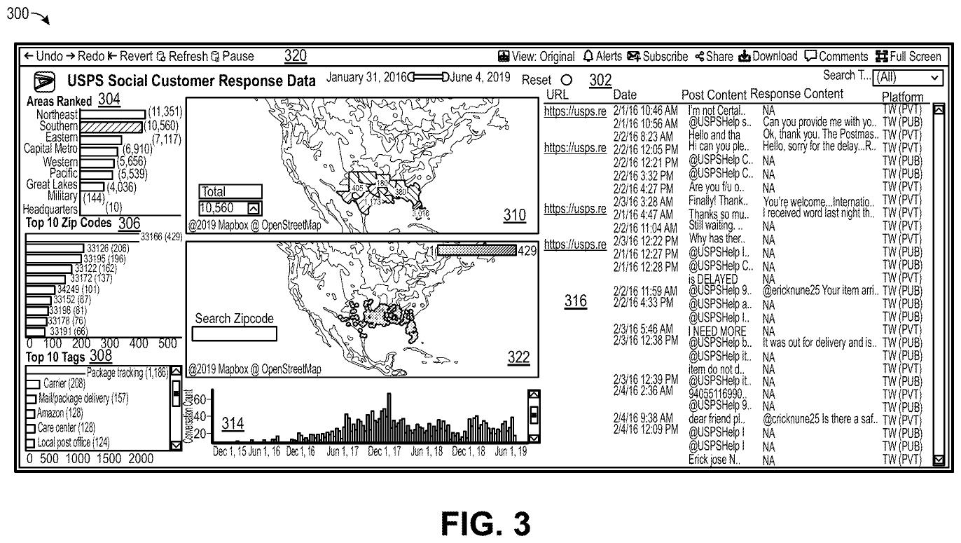

The master visualization data 218 may be processed to generate a visualization 220, which may include one or more heatmaps. The visualization 220 may be displayed as a graphical user interface by a computer communicatively coupled to the master data 218. According to some embodiments, the visualization 220 may be displayed on a graphical web page by a cloud-based virtual machine and accessible through a password-protected URL. The heat map(s) may be further processed, customized, and/or viewable by a user 222. Examples of such visualizations are shown and described herein in reference to FIG. 3.

FIG. 3 is a graphical user interface showing visualization dashboard 300, including a heatmap representing electronic operational feedback, according to various embodiments. The visualization dashboard 300 may implement the heatmap 106 as shown and described in reference to FIG. 1 and the visualization 220 as shown and described in reference to FIG. 2. The dashboard 300 depicted in FIG. 3 displays other visualizations, by way of non-limiting example, as presented herein.

In general, the dashboard 300 may be interactive. For example, clicking on any of the components of the dashboard 300 may change the entire graphical user interface to reflect the data selected by the click. Shown in FIG. 3 is the result of a user clicking on the “Southern” bar in the “Areas Ranked” bar graph 304, which results in the other visualizations, e.g., the heatmap 322 and data tables, showing data only for the Southern Area.

The top bar 320 includes several navigational features. For example, clicking on “undo” will take a user a step back, and “revert” serves as a universal reset button for all of the parameters in the dashboard 300.

Under the top bar is the date and search bar 302. Users can change the date range depicted in the displayed visualizations by toggling the slide of the date and search bar 302. As is the case for other features, this widget will affect the entire dashboard 300 according to various embodiments. According to some embodiments, clicking on the date causes a calendar to appear, on which a date range may be selected.

The date and search bar 302 also includes a “reset” button, which preserves the selected timeframe but reverts to a baseline for all other parameters. If performing multiple queries within the same timeframe, “reset” may be preferable to “revert.”

The dashboard 300 includes a heatmap window 322. The heatmap window 322 shows a heatmap for a geographic region, (e.g., the selected “Southern area”), over the selected timeframe for the selected electronic operational feedback data type. As shown in FIG. 3, the heat map represents an interactive map of the count of operational feedback by ZIP Code. A user can zoom in and out as well as drag the map to view other parts of the country. Clicking on a ZIP Code will filter the entire dashboard 300 to the selected ZIP Code.

The heatmap window 322 also includes a part search field. Several partition part resolutions may be searched, including, by way of non-limiting example, ZIP Code, state, or region. Searching for a specific geographic part, e.g., a ZIP Code, will update the entire dashboard 300, including the heatmap 322, to represent data only for that part.

The dashboard 300 includes a count-per-part window 310, which depicts the selected area partitioned into the next smallest geographic part type, e.g., countries may be partitioned into regions, regions may be partitioned into states, and states may be partitioned into ZIP Codes. The count-per-part window 310 displays the counts of the selected electronic operational feedback type data for each part. As shown in the example of FIG. 3, the Southern region is partitioned into states, (e.g., each state shown is a geographic part), and the count-per-part window 310 depicts the counts of social media communications per state.

The dashboard 300 includes an areas ranked window 304. The areas ranked window 304 presents a bar graph showing the number of electronic operational feedback data by predefined areas, most of which correspond to geographic regions, as well as numerals for the corresponding numeric values, over the selected date range. As shown in FIG. 3, a user has clicked on the bar for the Southern area.

The dashboard 300 also includes a top ten ZIP Codes window 306. The top ten ZIP Codes window 306 presents a bar graph showing the top ten ZIP Codes in terms of number of electronic operational feedback data, as well as numerals for the corresponding numeric values, over the selected date range. A user may click on any of the bars to change the visualizations, including the count-per-part window 310 and the heatmap window 322, for the selected ZIP Code.

The dashboard 300 also includes a top ten tags window 308. The top ten tags 308 displays a bar graph showing the top ten tags in the electronic operational feedback data, as well as numerals for the corresponding numeric values, over the selected date range. A user may click on any of the bars to change the visualizations, including the count-per-part window 310 and the heatmap window 322, for the selected tag.

The date and search bar 302 includes a search tags field. Clicking on the search tags field will bring up a menu of tags, of which one or more may be selected. Selecting a tag will update the dashboard 300 relative to the selected tag. For example, the count-per-part window 310 will display the counts of the selected tag, and the heatmap window 322 will display heatmap data representing the selected tag. Further, a user can select a location and from there have displayed top zip codes by volume (or customer rating) and top ten customer concerns.

The dashboard 300 also includes an operational feedback data over time window 314. The operational feedback over time window 318 displays a graph of operational feedback volume in terms of data count over the selected timeframe.

The dashboard also includes an operational feedback table window 316. The operational feedback table window 316 displays a table regarding each instance of social media type operational feedback data, thus providing an interface to review individual conversations. The table in the operational feedback table window 316 has the following columns:
URL—URL for the social media communication;
Date—Date when communication was submitted by to commentator;
Post Content—Content of the original post;
Response Content—Content of any response from the package delivery service; and
Platform—Identification of the social media platform and indication of whether the communication is public or private.

The contents of the operational feedback table window 316 are sorted chronologically and by conversation. Messages are grouped by conversation, such that the URL for the conversation (in the URL column) only appears once per conversation.

Although depicted relative to volume of social media communications in FIG. 3, dashboards according to various embodiments are not so limited. Dashboards according to some embodiments display visualizations relative to other types of electronic operational feedback and corresponding visualization data. For example, a dashboard according to various embodiments may display a heatmap representing any of: number of social media communications (combined or individually: posts, direct messages), number of email messages, number of phone messages (combined or individually: aural, textual), number of web-based ratings for each rating possibility (e.g., for each number of stars from zero to a maximal number of stars, or for each sentiment category, such as positive, neutral, or negative), total number of web-based ratings, number of employee satisfaction ratings for each rating possibility (e.g., for each number of stars from zero to a maximal number of stars, or for each sentiment category, such as positive, neutral, or negative), total number of employee satisfaction ratings, number of tags of each tag type, delivery delay times, communication response and/or issue resolution times (e.g., for email communications, aural phone message communications, textual phone message communications, social media post communications, social media direct message communications, or all types of communications combined), total number of feedback entries in all categories, etc.

An embodiment of the invention has achieved commercial success, and a summary of various quantification thereof and an associated award follows. An embodiment won a Platinum Award in the Data and Measurement category, conferred by PR News on Oct. 12, 2022. An embodiment also won an Honorable Mention conferred by PR Daily.

Further, locations that used an embodiment saw a 32% decrease in concerns on social media. For example, US Post Office locations that shared data, e.g., as represented in FIG. 3, in in-person sessions showed such a decrease. Moreover, this decrease was found to be statistically significant, in that the probability that the decrease arose by chance was less than 5%. Overall, locations that used an embodiment demonstrated a decrease of 31% with “Where is My Mail concerns,” a decrease of 57% with certified mail concerns, and a decrease of 85% with “Where is My Mail” concerns. These results were show to be statistically significant. Such locations also saw an 18% decrease in Electronic Care Cases resulting from those calling the toll-free number.

Further, the Southern Area began sharing online review data on a weekly basis with those in the field. This data included postal district, zip code, and individual online reviews with scores and comments. From Jan. 1, 2021 to July, 2023, the average online review score (scale of 1-5) increased from 2.260 in 2021 to 2.652 in 2023, an increase of 17%.

Yet further, before using an embodiment, a number of concerns arising from customers averaged 67 per month, and after using an embodiment, the average number of concerns decreased to 45.5, a decrease of 32%. Moreover, this decrease was found to be statistically significant, in that the probability that the decrease arose by chance was less than 5%.

Certain embodiments can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A method of detecting and remediating logistical operational delays, the method comprising:
obtaining, by an electronic processor, electronic operational feedback associated with logistics in a geographical region, wherein the electronic operational feedback comprises at least one of: customer email messages, customer phone messages, web-based customer reviews, delivery delay times, social media communication issue resolution times, or employment satisfaction ratings;
generating, by the electronic processor, a heatmap representing the electronic operational feedback for the geographical region, wherein an operational issue hotspot corresponding to a logistical node in the geographic region is displayed; and
remediating an operation issue at the logistical node in the geographic region that corresponds to the operational issue hotspot.

2. The method of claim 1, wherein the remediating comprises increasing a number of operational sorting machines at the logistical node.

3. The method of claim 1, wherein the remediating comprises increasing an amount of storage space at the logistical node.

4. The method of claim 1, wherein the remediating comprises increasing a number of vehicle interactions with the logistical node.

5. The method of claim 1, wherein the heatmap is partitioned according to ZIP Codes.

6. The method of claim 1, wherein the logistical node comprises a hub or a distribution center.

7. The method of claim 1, further comprising:
obtaining second electronic operational feedback comprising social media communications; and
displaying a second heatmap representing the second operation feedback.

8. The method of claim 1, wherein the heatmap is partitioned into geographic parts, and wherein the electronic operational feedback comprises at least one of: customer email messages or customer phone messages, the method further comprising:
extracting package tracking information from the electronic operational feedback; and
determining the geographic parts corresponding to the package tracking information.

9. The method of claim 1, wherein the electronic operational feedback comprises at least one of: customer email messages or customer phone messages, the method further comprising:
extracting a tag from the electronic operational feedback; and
displaying a second heatmap representing a frequency of the tag for the geographical region.

10. The method of claim 1, wherein the electronic operational feedback comprises at least one of: customer email messages or customer phone messages, the method further comprising:
displaying a second heatmap representing operational feedback response times.

11. A system for detecting and remediating logistical operational delays, the system comprising an electronic processor and a non-transitory computer readable medium comprising instruction that when executed by the electronic processor cause the electronic processor to perform actions comprising:
obtaining electronic operational feedback associated with logistics in a geographical region, wherein the electronic operational feedback comprises at least one of: customer email messages, customer phone messages, web-based customer reviews, delivery delay times, social media communication issue resolution times, or employment satisfaction ratings; and
generating a heatmap representing the electronic operational feedback for the geographical region, wherein an operational issue hotspot corresponding to a logistical node in the geographic region is displayed;
wherein an operation issue is remediated at the logistical node in the geographic region that corresponds to the operational issue hotspot.

12. The system of claim 11, wherein the operational issue is remediated by increasing a number of operational sorting machines at the logistical node.

13. The system of claim 11, wherein the operational issue is remediated by increasing an amount of storage space at the logistical node.

14. The system of claim 11, wherein the operational issue is remediated by increasing a number of vehicle interactions with the logistical node.

15. The system of claim 11, wherein the heatmap is partitioned according to ZIP Codes.

16. The system of claim 11, wherein the logistical node comprises a hub or a distribution center.

17. The system of claim 1, wherein the actions further comprise:
obtaining second electronic operational feedback comprising social media communications; and
displaying a second heatmap representing the second operation feedback.

18. The system of claim 11, wherein the heatmap is partitioned into geographic parts, and wherein the electronic operational feedback comprises at least one of: customer email messages or customer phone messages, the actions further comprising:
extracting package tracking information from the electronic operational feedback; and
determining the geographic parts corresponding to the package tracking information.

19. The system of claim 11, wherein the electronic operational feedback comprises at least one of: customer email messages or customer phone messages, the actions further comprising:
extracting a tag from the electronic operational feedback; and
displaying a second heatmap representing a frequency of the tag for the geographical region.

20. The system of claim 11, wherein the electronic operational feedback comprises at least one of: customer email messages or customer phone messages, the actions further comprising:
displaying a second heatmap representing operational feedback response times.
